(19) United States
(12) Patent Application Publication
(10) Pub. No.: US 2015/0123791 A1
(43) Pub. Date: May 7, 2015

(54) TRACKING SYSTEM AND METHOD

(71) Applicant: Patient Innovations, LLC, Hauppauge, NY (US)

(72) Inventors: KENNETH L. GREENBERG, Mount Sinai, NY (US); Akram Boutros, Cleveland, OH (US)

(21) Appl. No.: 14/532,979

(22) Filed: Nov. 4, 2014

Related U.S. Application Data
(60) Provisional application No. 61/899,394, filed on Nov. 4, 2013.
(60) Provisional application No. 62/018,022, filed on Jun. 27, 2014.

(51) Int. Cl. G06Q 50/22; G01S 5/16; G06Q 10/10; G01S 5/02

(52) U.S. Cl. CPC G06Q 50/22; G01S 5/0263; G01S 5/0294; G01S 5/16; G06Q 10/1091
USPC 340/539.13

(57) ABSTRACT

A method, computer program product, and computing system for receiving IR-based location information and RFID-based location information for each of a plurality of RFID/IR tags that are associated with and configured to be attached to a plurality of medical device within a medical facility. Position information is generated concerning each of the RFID/IR tags within the medical facility.

### RELATED APPLICATION

This application claims the benefit of U.S. Provisional Patent Application No. 61/899,394, entitled “Abstract of RFID Patient Flow Monitoring” and filed on 4 Nov. 2013; the entire contents of which are herein incorporated by reference.

This application claims the benefit of U.S. Provisional Patent Application No. 62/018,022, entitled “Abstract of RFID Patient Flow Monitoring” and filed on 27 Jun. 2014; the entire contents of which are herein incorporated by reference.

### TECHNICAL FIELD

This disclosure relates to tracking systems and, more particularly, to systems that track the movement and encounters of medical professionals, staff, patients and devices within a medical facility.

### BACKGROUND

In various types of businesses, organizations and institutions (e.g., medical facilities, office buildings, general workplaces, factories, and warehouses), numerous people and devices/equipment may be utilized to perform various tasks. Unfortunately, when these businesses, organizations and institutions are large, the monitoring of the location and utilization of these people and devices/equipment may prove to be an arduous task.

While active monitoring is possible (e.g., requiring the people to fill out time sheets that identify their utilization), the accuracy of such time sheets is directly dependent upon the ability/motivation of the people filling them out. Further, the movement/utilization of devices/equipment is more difficult, as it would require a person to actively monitor the use of these devices/equipment.

### SUMMARY OF DISCLOSURE

A computer-implemented method includes receiving IR-based location information and RFID-based location information for each of a plurality of RFID/IR tags that are associated with and configured to be attached to a plurality of medical device within a medical facility. Position information is generated concerning each of the RFID/IR tags within the medical facility.

One or more of the following features may be included. Time stamp information may be associated with the IR-based location information and the RFID-based location information received for each of the plurality of RFID/IR tags. Time-based movement information may be generated concerning each of the RFID/IR tags within the medical facility. At least one of the plurality of RFID/IR tags may be associated with and configured to be releasably attached to at least one medical patient. At least one of the plurality of RFID/IR tags may be associated with and configured to be releasably attached to at least one medical professional. A time/proximity based level of performance may be determined between at least one medical device, chosen from the plurality of medical devices, and the at least one medical patient or the at least one medical professional. The time/proximity based level of performance between the at least one medical device and the at least one medical patient or the at least one medical professional may be based, at least in part, upon: the IR-based location information received for the RFID/IR tag associated with the at least one medical device and the RFID/IR tag associated with the at least one medical patient or the at least one medical professional; the RFID-based location information received for the RFID/IR tag associated with the at least one medical device and the RFID/IR tag associated with the at least one medical patient or the at least one medical professional; and the time stamp information associated with the IR-based location information and the RFID-based location information received for the RFID/IR tag associated with the at least one medical device and the RFID/IR tag associated with the at least one medical patient or the at least one medical professional. The time/proximity based level of performance nay concern one or more of: the quantity of time that the at least one medical device is utilized for the at least one medical patient; the quantity of time that the at least one medical device is utilized by the at least one medical professional; the overall utilization efficiency of the medical device; the quantity of time that the at least one medical device is over-utilized; and the quantity of time that the at least one medical device is under-utilized. Receiving IR-based location information and RFID-based location information for each of a plurality of RFID/IR tags may include: receiving IR-based location information from a plurality of IR-based sensors positioned within the medical facility; and receiving RFID-based location information from a plurality of RFID-based sensors positioned within the medical facility. Each of the plurality of IR-based sensors and the plurality of RFID-based sensors may have a known location within the medical facility.

In another implementation, a computer program product resides on a computer readable medium that has a plurality of instructions stored on it. When executed by a processor, the instructions cause the processor to perform operations including receiving IR-based location information and RFID-based location information for each of a plurality of RFID/IR tags that are associated with and configured to be attached to a plurality of medical device within a medical facility. Position information is generated concerning each of the RFID/IR tags within the medical facility.

One or more of the following features may be included. Time stamp information may be associated with the IR-based location information and the RFID-based location information received for each of the plurality of RFID/IR tags. Time-based movement information may be generated concerning each of the RFID/IR tags within the medical facility. At least one of the plurality of RFID/IR tags may be associated with and configured to be releasably attached to at least one medical patient. At least one of the plurality of RFID/IR tags may be associated with and configured to be releasably attached to at least one medical professional. A time/proximity based level of performance may be determined between at least one medical device, chosen from the plurality of medical devices, and the at least one medical patient or the at least one medical professional. The time/proximity based level of performance between the at least one medical device and the at least one medical patient or the at least one medical professional may be based, at least in part, upon: the IR-based location information received for the RFID/IR tag associated with the at least one medical device and the RFID/IR tag associated with the at least one medical patient or the at least one medical professional; the RFID-based location information received for the RFID/IR tag associated with the at least one medical device and the RFID/IR tag associated with the at least one medical patient or the at least one medical professional; and the time stamp information associated with the IR-based location information and the RFID-based location information received for the RFID/IR tag associated with the at least one medical device and the RFID/IR tag associated with the at least one medical patient or the at least one medical professional. The time/proximity based level of performance nay concern one or more of: the quantity of time that the at least one medical device is utilized for the at least one medical patient; the quantity of time that the at least one medical device is utilized by the at least one medical professional; the overall utilization efficiency of the medical device; the quantity of time that the at least one medical device is over-utilized; and the quantity of time that the at least one medical device is under-utilized. Receiving IR-based location information and RFID-based location information for each of a plurality of RFID/IR tags may include: receiving IR-based location information from a plurality of IR-based sensors positioned within the medical facility; and receiving RFID-based location information from a plurality of RFID-based sensors positioned within the medical facility. Each of the plurality of IR-based sensors and the plurality of RFID-based sensors may have a known location within the medical facility.

In another implementation, a computing system includes at least one processor and at least one memory architecture coupled with the at least one processor, wherein the computing system is configured to perform operations including receiving IR-based location information and RFID-based location information for each of a plurality of RFID/IR tags that are associated with and configured to be attached to a plurality of medical device within a medical facility. Position information is generated concerning each of the RFID/IR tags within the medical facility.

One or more of the following features may be included. Time stamp information may be associated with the IR-based location information and the RFID-based location information received for each of the plurality of RFID/IR tags. Time-based movement information may be generated concerning each of the RFID/IR tags within the medical facility. At least one of the plurality of RFID/IR tags may be associated with and configured to be releasably attached to at least one medical patient. At least one of the plurality of RFID/IR tags may be associated with and configured to be releasably attached to at least one medical professional. A time/proximity based level of performance may be determined between at least one medical device, chosen from the plurality of medical devices, and the at least one medical patient or the at least one medical professional. The time/proximity based level of performance between the at least one medical device and the at least one medical patient or the at least one medical professional may be based, at least in part, upon: the IR-based location information received for the RFID/IR tag associated with the at least one medical device and the RFID/IR tag associated with the at least one medical patient or the at least one medical professional; the RFID-based location information received for the RFID/IR tag associated with the at least one medical device and the RFID/IR tag associated with the at least one medical patient or the at least one medical professional; and the time stamp information associated with the IR-based location information and the RFID-based location information received for the RFID/IR tag associated with the at least one medical device and the RFID/IR tag associated with the at least one medical patient or the at least one medical professional. The time/proximity based level of performance nay concern one or more of: the quantity of time that the at least one medical device is utilized for the at least one medical patient; the quantity of time that the at least one medical device is utilized by the at least one medical professional; the overall utilization efficiency of the medical device; the quantity of time that the at least one medical device is over-utilized; and the quantity of time that the at least one medical device is under-utilized. Receiving IR-based location information and RFID-based location information for each of a plurality of RFID/IR tags may include: receiving IR-based location information from a plurality of IR-based sensors positioned within the medical facility; and receiving RFID-based location information from a plurality of RFID-based sensors positioned within the medical facility. Each of the plurality of IR-based sensors and the plurality of RFID-based sensors may have a known location within the medical facility.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a tracking & analysis process according to an implementation of the present disclosure;

FIG. 2 is a diagrammatic view of an environment being monitored by the tracking & analysis process of FIG. 1 according to an implementation of the present disclosure; and

FIG. 3 is a flowchart of the tracking & analysis process of FIG. 1 according to an implementation of the present disclosure.

Like reference symbols in the various drawings indicate like elements.

### DETAILED DESCRIPTION OF THE PREFERRED EMBODIMENTS

### System Overview:

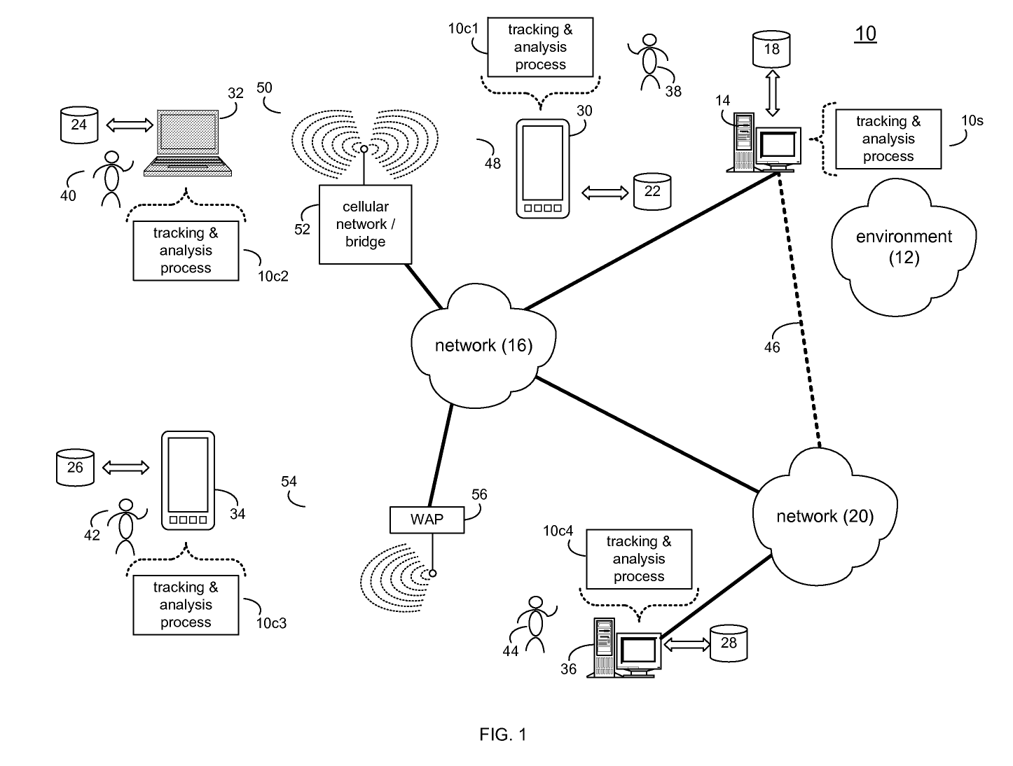

Referring to FIG. 1, there is shown tracking & analysis process 10. As will be discussed below in greater detail, tracking & analysis process 10 may be utilized to track various objects (e.g., medical professionals, medical staff, medical patients, medical devices, etc.) as they move within environment 12 (e.g., a medical facility) and interact with each other. Tracking & analysis process 10 may be configured to gather interaction data concerning these various objects (e.g., medical professionals, medical staff, medical patients, medical devices, etc.) within environment 12 (e.g., a medical facility) so that tracking & analysis process 10 may calculate and compile statistics concerning e.g., the utilization and efficiency and these various objects (e.g., medical professionals, medical staff, medical patients, medical devices, etc.). While one example of environment 12 is a medical facility, this is for illustrative purposes only and is not intended to be a limitation of this disclosure, as other configurations are possible and are considered to be within the scope of this disclosure. Other examples may include but are not limited to office buildings, workplaces, factories, warehouses, etc.

Tracking & analysis process 10 may be implemented as a server-side process, a client-side process, or a hybrid server-side/client-side process. For example, tracking & analysis process 10 may be implemented as a purely server-side process via tracking & analysis process 10s. Alternatively, tracking & analysis process 10 may be implemented as a purely client-side process via one or more of client-side process 10c1, client-side process 10c2, client-side process 10c3, and client-side process 10c4. Alternatively still, tracking & analysis process 10 may be implemented as a hybrid server-side/client-side process via tracking & analysis process 10s in combination with one or more of client-side process 10c1, client-side process 10c2, client-side process 10c3, and client-side process 10c4. Accordingly, tracking & analysis process 10 as used in this disclosure may include any combination of tracking & analysis process 10s, client-side process 10c1, client-side process 10c2, client-side process 10c3, and client-side process 10c4.

Tracking & analysis process 10s may be a server application and may reside on and may be executed by computing device 14, which may be connected to network 16 (e.g., the Internet or a local area network). Examples of computing device 14 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a dedicated network device.

The instruction sets and subroutines of tracking & analysis process 10s, which may be stored on storage device 18 coupled to computing device 14, may be executed by one or more processors (not shown) and one or more memory architectures (not shown) included within computing device 14. Examples of storage device 18 may include but are not limited to: a hard disk drive; a tape drive; an optical drive; a RAID device; a random access memory (RAM); a read-only memory (ROM); and all forms of flash memory storage devices.

Network 16 may be connected to one or more secondary networks (e.g., network 20), examples of which may include but are not limited to: a local area network; a wide area network; or an intranet, for example.

Examples of client-side processes 10c1, 10c2, 10c3, 10c4 may include but are not limited to a web browser, a specialized desktop application, a game console user interface, or a specialized handheld application (e.g., an application running on e.g., the Android™ platform or the iPhone™ platform). The instruction sets and subroutines of client-side applications 10c1, 10c2, 10c3, 10c4, which may be stored on storage devices 22, 24, 26, 28 (respectively) coupled to client electronic devices 30, 32, 34, 36 (respectively), may be executed by one or more processors (not shown) and one or more memory architectures (not shown) incorporated into client electronic devices 30, 32, 34, 36 (respectively). Examples of storage devices 22, 24, 26, 28 may include but are not limited to: hard disk drives; tape drives; optical drives; RAID devices; random access memories (RAM); read-only memories (ROM), and all forms of flash memory storage devices.

Examples of client electronic devices 30, 32, 34, 36 may include, but are not limited to, data-enabled, cellular telephone 30, laptop computer 32, personal digital assistant 34, personal computer 36, a notebook computer (not shown), a server computer (not shown), a gaming console (not shown), a smart television (not shown), and a dedicated network device (not shown). Client electronic devices 30, 32, 34, 36 may each execute an operating system, examples of which may include but are not limited to Microsoft Windows™, Android™, WebOS™, iOS™, Redhat Linux™, or a custom operating system.

Users 38, 40, 42, 44 may access tracking & analysis process 10 directly through network 16 or through secondary network 20. Further, tracking & analysis process 10 may be connected to network 16 through secondary network 20, as illustrated with link line 46.

The various client electronic devices (e.g., client electronic devices 30, 32, 34, 36) may be directly or indirectly coupled to network 16 (or network 20). For example, data-enabled, cellular telephone 30 and laptop computer 32 are shown wirelessly coupled to network 16 via wireless communication channels 48, 50 (respectively) established between data-enabled, cellular telephone 30, laptop computer 32 (respectively) and cellular network/bridge 52, which is shown directly coupled to network 16. Further, personal digital assistant 34 is shown wirelessly coupled to network 16 via wireless communication channel 54 established between personal digital assistant 34 and wireless access point (i.e., WAP) 56, which is shown directly coupled to network 16. Additionally, personal computer 36 is shown directly coupled to network 20 via a hardwired network connection.

WAP 56 may be, for example, an IEEE 802.11a, 802.11b, 802.11g, 802.11n, Wi-Fi, and/or Bluetooth device that is capable of establishing wireless communication channel 54 between personal digital assistant 34 and WAP 56. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### System & Process Overview:

Tracking & analysis process 10 may be configured to track various objects (e.g., medical professionals, medical staff, medical patients, medical devices, etc.) within environment 12 (e.g., a medical facility, such as a doctor's office, a medical practice, an individual hospital, a hospital system, a medical complex, a medical system, a medical lab) and gather interaction and movement data concerning the same, so that tracking & analysis process 10 may calculate and compile statistical and efficiency data concerning e.g., the utilization of these various objects (e.g., medical professionals, medical staff, medical patients, medical devices, etc.).

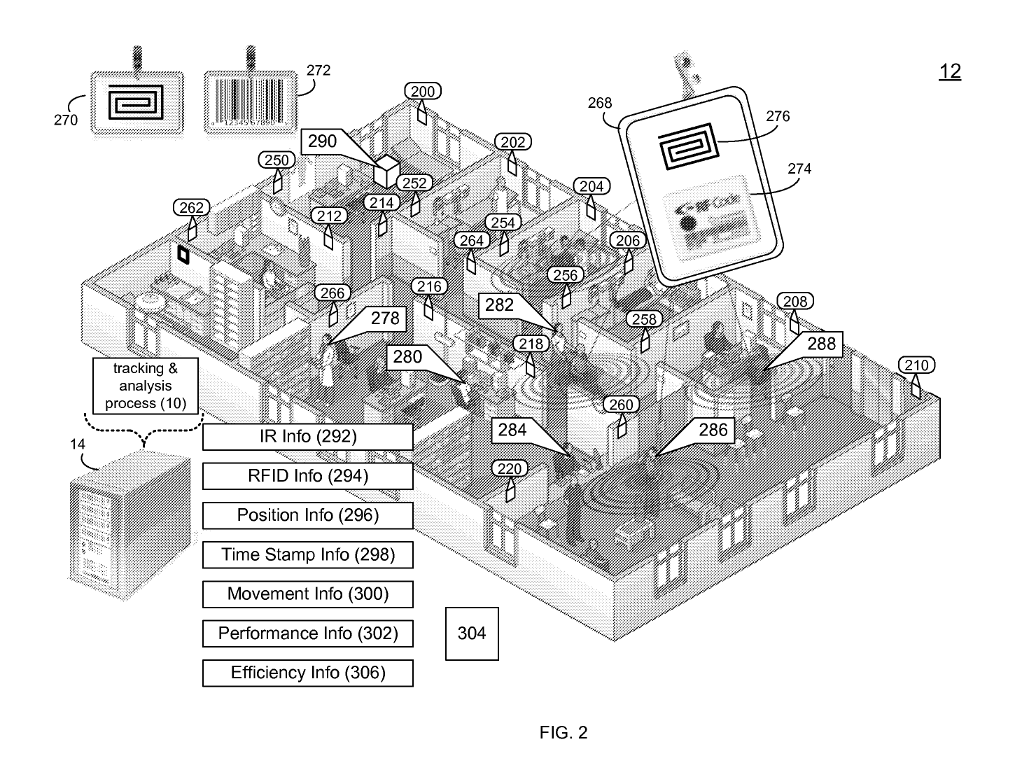

Referring also to FIG. 2 and as discussed above, tracking & analysis process 10 may reside on and may be executed by computing device 14, wherein computing device 14 may be coupled to and configured to interact with various other components within environment 12. As discussed above, while one example of environment 12 is a medical facility, this is for illustrative purposes only and is not intended to be a limitation of this disclosure, as other configurations are possible (e.g., office buildings, workplaces, factories, warehouses) and are considered to be within the scope of this disclosure.

Continuing with the above-stated example, computing device 14 may be coupled to and configured to interact with a plurality of IR-based sensors (e.g., IR-based sensors 200, 202, 204, 206, 208, 210, 212, 214, 216, 218, 220) positioned within environment 12. Ideally, IR-based sensors 200, 202, 204, 206, 208, 210, 212, 214, 216, 218, 220 may be positioned within each room in which object monitoring may be desired. Further, some rooms may include multiple sensors to ensure adequate coverage of the entire room. Additionally, in some rooms (e.g., lavatories), monitoring may not be desired and, therefore, sensors may not be included. As is known in the art, IR-based sensors are line-of-sight sensors that are configured to read optical identifying indicia (such as bar codes) that may be attached to the objects to be monitored within environment 12. Examples of such IR-based sensors may include but are not limited to an A750 Room Locator offered by RF Code of Austin, Tex.

Further, computing device 14 may be coupled to and configured to interact with a plurality of RFID-based sensors (e.g., RFID-based sensors 250, 252, 254, 256, 258, 260, 262, 264, 266) positioned within the environment 12. As with the IR-based sensors, the RFID-based sensors 250, 252, 254, 256, 258, 260, 262, 264, 266 may be positioned within each room in which object monitoring may be desired. Further, some rooms may include multiple sensors to ensure adequate coverage of the entire room and in other rooms (e.g., lavatories), where monitoring may not be desired, no sensors may be included. As is known in the art, RFID-based sensors do not require line-of-sight and are configured to receive RF-based identifying indicia (such as a unique identifier) from the objects to be monitored within environment 12. Examples of such RFID-based sensors may include but are not limited to an A760 Proximity Locator offered by RF Code of Austin, Tex.

While in this particular example, the system is shown to include discrete IR-based sensors and discrete RFID-based sensors, this is for illustrative purposes only and is not intended to be a limitation of this disclosure, as other configurations are possible and are considered to be within the scope of this disclosure. For example, hybrid IR/RFID sensors may be utilized that are capable of providing IR-based sensing and RFID-based sensing within environment 12.

Each of the plurality of IR-based sensors (e.g., IR-based sensors 200, 202, 204, 206, 208, 210, 212, 214, 216, 218, 220) and the plurality of RFID-based sensors (e.g., RFID-based sensors 250, 252, 254, 256, 258, 260, 262, 264, 266) may have a known location within environment 12. Therefore, when an object (e.g., a medical professional, a medical staff, a medical patient, a medical device, etc.) is sensed on e.g., IR-based sensor 200 and RFID-based sensor 250, since sensors 200, 250 are known to be located in “Examination Room A”, the location of the object being sensed (e.g., a medical professional, a medical staff, a medical patient, a medical device, etc.) could be determined to be “Examination Room A”.

While for the following discussion, each of the plurality of RFID/IR tags is going to be described as a one-piece tag (e.g., RFID/IR tag 268), other configurations are possible and are considered to be within the scope of this disclosure. For example, at least one of the plurality of RFID/IR tags may be a two-component RFID/IR tag, wherein a first component (e.g., first component 270) may be an RFID tag and a second component (e.g., second component 272) may be an IR tag.

A plurality of RFID/IR tags (e.g., RFID/IR tag 268) may be associated with and may be configured to be attached to a plurality of objects within environment 12. Examples of such RFID/IR tags (e.g., RFID/IR tag 268) may include but are not limited to M163-i IR Wristband Tags, M100 Asset Tags, M131 Thin Tags, and R142-i3RF IR-Enabled Proximity Badges, all of which are offered by RF Code of Austin, Tex.

As discussed above and in situations in which environment 12 is a medical facility, examples of this plurality of objects may include but is not limited to medical professionals, medical staff, medical patients and/or medical devices. RFID/IR tag 268 may include an IR component (e.g., IR barcode 274) and an RFID component (e.g., RFID coil 276). As is known in the art, IR barcode 274 may be configured to be read by IR-based sensors 200, 202, 204, 206, 208, 210, 212, 214, 216, 218, 220 and RFID coil 276 may be configured to be energized by RFID-based sensors 250, 252, 254, 256, 258, 260, 262, 264, 266 and provide identifying indicia (such as a unique identifier).

Continuing with the above-stated example, at least one of the plurality of objects may be a medical professional (e.g., doctor 278, nurse 280) and at least one of the RFID/IR tags may be configured to be releasably attached to the medical professional (e.g., doctor 278, nurse 280). For example, an RFID/IR tag may be included within an identification badge that is worn by the medical professional (e.g., doctor 278, nurse 280) and releasably attached to the medical professional (e.g., doctor 278, nurse 280) via a spring clasp. Alternatively, the RFID/IR tag may be a stand-alone tag that is worn by and releasably attached to the medical professional (e.g., doctor 278, nurse 280). Other examples of medical professionals may include but are not limited to dentists, pharmacists, midwives, psychologists, psychiatrists, dietitians, therapists, chiropractors, social workers, audiologists, speech pathologists, optometrists, emergency medical technicians, and paramedics.

Further, at least one of the plurality of objects may be a medical staff (e.g., orderly 282, receptionist 284) and at least one of the RFID/IR tags may be configured to be releasably attached to the medical staff (e.g., orderly 282, receptionist 284). For example, an RFID/IR tag may be included within an identification badge that is worn by the medical staff (e.g., orderly 282, receptionist 284) and releasably attached to the medical staff (e.g., orderly 282, receptionist 284) via a spring clasp. Alternatively, the RFID/IR tag may be a stand-alone tag that is worn by and releasably attached to the medical staff (e.g., orderly 282, receptionist 284). Other examples of medical staff may include but are not limited to kitchen workers, laundry workers, nurse assistants, nurse practitioners, and janitors.

Additionally, at least one of the plurality of objects may be a medical patient (e.g., patient 286, 288) and at least one of the RFID/IR tags may be configured to be releasably attached to the medical patient (e.g., patient 286, patient 288). For example, an RFID/IR tag may be a tag that is provided to the medical patient (e.g., patient 286, 288) when the medical patient (e.g., patient 286, 288) checks into the medical facility (e.g., environment 12) and is returned to the medical facility (e.g., environment 12) when the medical patient (e.g., patient 286, 288) checks out of the medical facility (e.g., environment 12).

Further, at least one of the plurality of objects may be a medical device (e.g., ultrasound machine 290) and at least one of the RFID/IR tags may be configured to be attached to the medical device (e.g., ultrasound machine 290). For example, the RFID/IR tag may be a tag that is attached to the medical device (e.g., ultrasound machine 290) is a fashion similar to that of an inventory control tag. Other examples of medical devices may include but are not limited to blood pressure machines, sonogram machines, x-ray machines, incubators, EKG machines, EEG machines, and infusion machines.

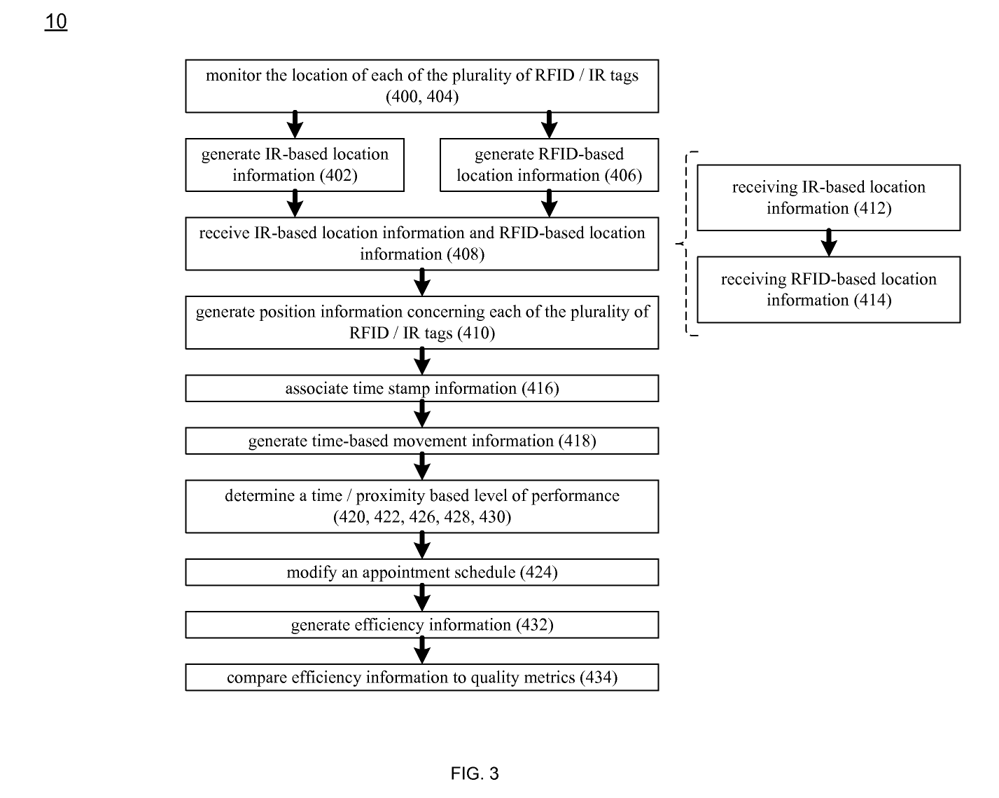

Referring also to FIG. 3, tracking & analysis process 10 (in combination with computing device 14 and IR-based sensors 200, 202, 204, 206, 208, 210, 212, 214, 216, 218, 220) may be configured to monitor 400 the location of each of the plurality of RFID/IR tags (e.g., the RFID/IR tags attached to doctor 278, nurse 280, orderly 282, receptionist 284, patient 286, patient 288, and ultrasound machine 290) within environment 12 and generate 402 IR-based location information 292 for each of the plurality of RFID/IR tags.

Tracking & analysis process 10 (in combination with computing device 14 and RFID-based sensors 250, 252, 254, 256, 258, 260, 262, 264, 266) may further be configured to monitor 404 the location of each of the plurality of RFID/IR tags (e.g., the RFID/IR tags attached to doctor 278, nurse 280, orderly 282, receptionist 284, patient 286, patient 288, and ultrasound machine 290) within the environment 12 and generate 406 RFID-based location information 294 for each of the plurality of RFID/IR tags.

Specifically and concerning generating 402 IR-based location information 292 and generating 406 RFID-based location information 294, tracking & analysis process 10 may receive 408 IR-based location information 292 and RFID-based location information 294 for each of the plurality of RFID/IR tags (e.g., the RFID/IR tags attached to doctor 278, nurse 280, orderly 282, receptionist 284, patient 286, patient 288, and ultrasound machine 290) that are associated with the various objects (e.g., medical professionals, medical staff, medical patients, medical devices, etc.) within environment 12 (e.g., a medical facility). Further, tracking & analysis process 10 may generate 410 position information 296 concerning each of the plurality of RFID/IR tags (e.g., the RFID/IR tags attached to doctor 278, nurse 280, orderly 282, receptionist 284, patient 286, patient 288, and ultrasound machine 290) within environment 12 (e.g., a medical facility).

Receiving 408 IR-based location information 292 and RFID-based location information 294 for each of the plurality of RFID/IR tags (e.g., the RFID/IR tags attached to doctor 278, nurse 280, orderly 282, receptionist 284, patient 286, patient 288, and ultrasound machine 290) may include: receiving 412 IR-based location information 292 from the plurality of IR-based sensors (e.g., IR-based sensors 200, 202, 204, 206, 208, 210, 212, 214, 216, 218, 220) positioned within the medical facility (e.g., environment 12); and receiving 414 RFID-based location information 294 from the plurality of RFID-based sensors (e.g., RFID-based sensors 250, 252, 254, 256, 258, 260, 262, 264, 266) positioned within the medical facility (e.g., environment 12).

Tracking & analysis process 10 (in combination with computing device 14) may be configured to associate 416 time stamp information 298 with IR-based location information 292 and RFID-based location information 294 received for each of the plurality of RFID/IR tags (e.g., the RFID/IR tags attached to doctor 278, nurse 280, orderly 282, receptionist 284, patient 286, patient 288, and ultrasound machine 290) that are associated with the various objects (e.g., medical professionals, medical staff, medical patients, medical devices, etc.) within environment 12 (e.g., a medical facility).

Once time stamp information 298 is associated 416 with IR-based location information 292 and RFID-based location information 294, tracking & analysis process 10 (in combination with computing device 14) may be configured to generate 418 time-based movement information 300 concerning each of the RFID/IR tags within environment 12 (e.g., a medical facility). Time-based movement information 300 may provide temporal movement information concerning each of the RFID/IR tags within environment 12 (e.g., a medical facility) and, therefore, the various objects (e.g., doctor 278, nurse 280, orderly 282, receptionist 284, patient 286, patient 288, and ultrasound machine 290) to which those RFID/IR tags are attached. Accordingly, time-based movement information 300 may provide a time-line for e.g., doctor 278 that illustrates that doctor 278 was e.g., in a “Common Area” from 9:00 a.m. until 9:45 a.m., in “Examination Room A” from 9:45 a.m. until 10:00 a.m., and in his office from 10:00 a.m. until 12:00 p.m.

### Performance Analysis:

Tracking & analysis process 10 (in combination with computing device 14) may be configured to determine 420 a time/proximity based level of performance (e.g., performance information 302) between at least two of the plurality of RFID/IR tags based, at least in part, upon IR-based location information 292, RFID-based location information 294, and time stamp information 298. As will be discussed below in greater detail and through the use of tracking & analysis process 10, the interactions of various RFID/IR tags (and the various objects to which they are attached) may be monitored and analyzed. For example, tracking & analysis process 10 may determine: the quantity of time that a medical professional (e.g., doctor 278, nurse 280) meets with patients (e.g., patient 286, 288); the quantity of time that a medical professional (e.g., doctor 278, nurse 280) is in their office; the quantity of time that a medical professional (e.g., doctor 278, nurse 280) is scheduled to meet with a patient versus the quantity of time that the medical professional actually meets with the patient; the quantity of time that a medical device (e.g., ultrasound machine 290) is utilized per patient or over a defined period of time; and the quantity of time that a medical staff (e.g., orderly 282, receptionist 284) takes to perform a task.

Generally speaking and through the use of performance information 302 determined 420 by tracking & analysis process 10 (in combination with computing device 14), the movement of objects (e.g., doctor 278, nurse 280, orderly 282, receptionist 284, patient 286, patient 288, and ultrasound machine 290) within environment 12 (e.g., a medical facility) may be monitored in a long-term, time-based fashion, thus allowing the user of tracking & analysis process 10 to identify task completion times and object interaction levels and gauge the performance of the objects within environment 12.

As discussed above, performance information 302 may be based upon various criteria, such as object movement, object interaction and object utilization. Further, since tracking & analysis process 10 (in combination with computing device 14) may be configured to perform this analysis over a defined period of time (e.g., a day, a week, a month, a year), the overall performance of an object within environment 12 may be determined, thus enabling trends to emerge that would have been difficult to identify manually.

For example, tracking & analysis process 10 (in combination with computing device 14) may determine 420 performance information 302 indicating e.g., that a particular medical device has not moved or been used for an entire six month period; that patients send on average 38 minutes in the waiting room before being placed into an examination/procedure room; that the quantity of time that a particular doctor interacts with patients decreases during the winter months; that the utilization level of a portable x-ray machine increases in the summer months; that it takes orderlies longer in summer months to distribute meals than in winter months; that Doctor A is meeting with patients 54% of the time that they are in the medical facility, while Doctor B is meeting with patients only 14% of the time that they are in the medical facility; that Doctor C spends only 6% of the time that they are in the medical facility in their office, while Doctor D spends 72% of the time that they are in the medical facility in their office; and that Doctor E spends 16% of the time that they are in the medical facility interacting with medical staff, while Doctor F spends on 2% of the time that they are in the medical facility interacting with medical staff.

Additionally and when determining 420 performance information 302, tracking & analysis process 10 (in combination with computing device 14) may be configured to take into consideration the purpose of the visit to environment 12. For example, it may be determined through performance information 302 that patients that visit the medical facility (e.g., environment 12) for routine check-up meet with a doctor on average 15 minutes after they are placed into an examination/procedure room, while patients that visit the medical facility (e.g., environment 12) complaining of head pain meet with a doctor on average 48 minutes after they are placed into an examination/procedure room (e.g., thus indicating that the doctor specializing in head pain is over-scheduled). Further, it may be determined through performance information 302 that doctors within the medical facility (e.g., environment 12) spend an average of 12 minutes meeting with a influenza patient, yet influenza appointments are scheduled 10 minutes apart, resulting in delays increasing during the course of the day (e.g., thus indicating that the appointments should be spaced e.g., 15 minutes apart).

Additionally, performance information 302 determined 420 by tracking & analysis process 10 (in combination with computing device 14) may be utilized to gauge the performance of patients. For example, performance information 302 may be used to indicate that Patient A is notoriously late for early morning appointments, yet seems to always arrive early for afternoon appoints (e.g., maybe only schedule Patient A for afternoon appointments). Patient B tends to routinely cancel afternoon appointments during the school year, yet they are very good at keeping midday appointments during the school year (e.g., maybe only schedule Patient B for midday appointments).

While the system is described above as determining 420 performance information 302 on an individualized level, this is for illustrative purposes only and is not intended to be a limitation of this disclosure, as other configurations are possible and are considered to be within the scope of this disclosure. For example, tracking & analysis process 10 (in combination with computing device 14) may be configured to determine 420 performance information 302 on a per facility/per group/per task/per time period basis. Accordingly and through the use of performance information 302, the utilization levels of the individual doctors with environment 12 may be averaged over the course of a calendar year, thus providing an average doctor utilization level for environment 12 as a whole, wherein these utilization levels may be monitored on a year-to-year basis to determine whether environment-wide improvement is occurring.

Medical Professional Analysis:

For example, tracking & analysis process 10 (in combination with computing device 14) may be configured to determine 422 a time/proximity based level of performance (e.g., performance information 302) between at least one medical professional (e.g., doctor 278, nurse 280), chosen from the plurality of medical professionals; and the at least one medical patient (e.g., patient 286, 288) or the at least one medical device (e.g., ultrasound machine 290).

This time/proximity based level of performance (e.g., performance information 302) between the at least one medical professional (e.g., doctor 278, nurse 280) and the at least one medical patient (e.g., patient 286, 288) or the at least one medical device (e.g., ultrasound machine 290) may be based, at least in part, upon: a) IR-based location information 292 received for the RFID/IR tag associated with the at least one medical professional (e.g., doctor 278, nurse 280) and the RFID/IR tag associated with the at least one medical patient (e.g., patient 286, 288) or the at least one medical device (e.g., ultrasound machine 290); b) RFID-based location information 294 received for the RFID/IR tag associated with the at least one medical professional (e.g., doctor 278, nurse 280) and the RFID/IR tag associated with the at least one medical patient (e.g., patient 286, 288) or the at least one medical device (e.g., ultrasound machine 290); and c) time stamp information 298 associated with IR-based location information 292 and RFID-based location information 294 received for the RFID/IR tag associated with the at least one medical professional (e.g., doctor 278, nurse 280) and the RFID/IR tag associated with the at least one medical patient (e.g., patient 286, 288) or the at least one medical device (e.g., ultrasound machine 290).

The time/proximity based level of performance (e.g., performance information 302) may concern one or more of: the quantity of time that the at least one medical professional (e.g., doctor 278, nurse 280) interacts with the at least one medical patient (e.g., patient 286, 288); the quantity of time that the at least one medical professional (e.g., doctor 278, nurse 280) utilizes the at least one medical device (e.g., ultrasound machine 290); the overall utilization efficiency of the at least one medical professional (e.g., doctor 278, nurse 280); the quantity of time that the at least one medical professional (e.g., doctor 278, nurse 280) is over-scheduled (e.g., scheduled to do too much work); and the quantity of time that the at least one medical professional (e.g., doctor 278, nurse 280) is under-scheduled (e.g., scheduled to do too little work).

Once the time/proximity based level of performance (e.g., performance information 302) has been determined, tracking & analysis process 10 (in combination with computing device 14) may be configured to modify 424 an appointment schedule (e.g., appointment schedule 304) of medical professional (e.g., doctor 278, nurse 280) based, at least in part, upon the time/proximity based level of performance (e.g., performance information 302) between the at least one medical professional (e.g., doctor 278, nurse 280) and the at least one medical patient (e.g., patient 286, 288).

Modifying 424 the appointment schedule (e.g., appointment schedule 304) of the medical professional (e.g., doctor 278, nurse 280) may include: a) one or more of: increasing the length of one or more current or future appointments included within appointment schedule 304 of the medical professional (e.g., doctor 278, nurse 280); b) decreasing the length of one or more current or future appointments included within appointment schedule 304 of the medical professional (e.g., doctor 278, nurse 280); c) increasing the quantity of one or more current or future appointments included within appointment schedule 304 of the medical professional (e.g., doctor 278, nurse 280); d) decreasing the quantity of one or more current or future appointments included within appointment schedule 304 of the medical professional (e.g., doctor 278, nurse 280); e) increasing the density of one or more current or future appointments included within appointment schedule 304 of the medical professional (e.g., doctor 278, nurse 280); f) decreasing the density one or more current or future appointments included within appointment schedule 304 of the medical professional (e.g., doctor 278, nurse 280); g) switching one or more current or future appointments to another medical professional; h) adding another medical professional to one or more current or future appointments; and i) eliminating one or more of the medical professionals from one or more current or future appointments.

Medical Patient Analysis:

Further, tracking & analysis process 10 (in combination with computing device 14) may be configured to determine 426 a time/proximity based level of performance (e.g., performance information 302) between at least one medical patient (e.g., patient 286, 288), chosen from the plurality of medical patients; and the at least one medical professional (e.g., doctor 278, nurse 280) or the at least one medical device (e.g., ultrasound machine 290).

This time/proximity based level of performance (e.g., performance information 302) between the at least one medical patient (e.g., patient 286, 288) and the at least one medical professional (e.g., doctor 278, nurse 280) or the at least one medical device (e.g., ultrasound machine 290) may be based, at least in part, upon: a) IR-based location information 292 received for the RFID/IR tag associated with the at least one medical patient (e.g., patient 286, 288) and the RFID/IR tag associated with the at least one medical professional (e.g., doctor 278, nurse 280) or the at least one medical device (e.g., ultrasound machine 290); b) RFID-based location information 294 received for the RFID/IR tag associated with the at least one medical patient (e.g., patient 286, 288) and the RFID/IR tag associated with the at least one medical professional (e.g., doctor 278, nurse 280) or the at least one medical device (e.g., ultrasound machine 290); and c) time stamp information 298 associated with IR-based location information 292 and RFID-based location information 294 received for the RFID/IR tag associated with the at least one medical patient (e.g., patient 286, 288) and the RFID/IR tag associated with the at least one medical professional (e.g., doctor 278, nurse 280) or the at least one medical device (e.g., ultrasound machine 290).

The time/proximity based level of performance (e.g., performance information 302) may concern one or more of: the quantity of time that the at least one medical patient (e.g., patient 286, 288) interacts with the at least one medical professional (e.g., doctor 278, nurse 280); the quantity of time that the at least one medical patient (e.g., patient 286, 288) utilizes the at least one medical device (e.g., ultrasound machine 290); the anticipated satisfaction level of the at least one medical patient (e.g., patient 286, 288); the quantity of time that the at least one medical patient (e.g., patient 286, 288) is over-scheduled; and the quantity of time that the at least one medical patient (e.g., patient 286, 288) is under-scheduled.

Medical Device Analysis:

Additionally, tracking & analysis process 10 (in combination with computing device 14) may be configured to determine 428 a time/proximity based level of performance (e.g., performance information 302) between at least one medical device (e.g., ultrasound machine 290), chosen from the plurality of medical devices; and the at least one medical patient (e.g., patient 286, 288) or the at least one medical professional (e.g., doctor 278, nurse 280).

This time/proximity based level of performance (e.g., performance information 302) between the at least one medical device (e.g., ultrasound machine 290) and the at least one medical patient (e.g., patient 286, 288) or the at least one medical professional (e.g., doctor 278, nurse 280) may be based, at least in part, upon: a) the IR-based location information received for the RFID/IR tag associated with the at least one medical device (e.g., ultrasound machine 290) and the RFID/IR tag associated with the at least one medical patient (e.g., patient 286, 288) or the at least one medical professional (e.g., patient 286, 288); b) RFID-based location information 294 received for the RFID/IR tag associated with the at least one medical device (e.g., ultrasound machine 290) and the RFID/IR tag associated with the at least one medical patient (e.g., patient 286, 288) or the at least one medical professional (e.g., patient 286, 288); and c) time stamp information 298 associated with IR-based location information 292 and RFID-based location information 294 received for the RFID/IR tag associated with the at least one medical device (e.g., ultrasound machine 290) and the RFID/IR tag associated with the at least one medical patient (e.g., patient 286, 288) or the at least one medical professional (e.g., patient 286, 288).

The time/proximity based level of performance (e.g., performance information 302) may concern one or more of: the quantity of time that the at least one medical device (e.g., ultrasound machine 290) is utilized for the at least one medical patient; the quantity of time that the at least one medical device (e.g., ultrasound machine 290) is utilized by the at least one medical professional; the overall utilization efficiency of the medical device (e.g., ultrasound machine 290); the quantity of time that the at least one medical device (e.g., ultrasound machine 290) is over-utilized/scheduled; and the quantity of time that the at least one medical device (e.g., ultrasound machine 290) is under-utilized/scheduled.

Medical Staff Analysis:

Additionally, tracking & analysis process 10 (in combination with computing device 14) may be configured to determine 430 a time/proximity based level of performance (e.g., performance information 302) for at least one medical staff (e.g., orderly 282, receptionist 284), chosen from the plurality of medical staff.

This time/proximity based level of performance (e.g., performance information 302) for at least one medical staff (e.g., orderly 282, receptionist 284) may be based, at least in part, upon: a) IR-based location information 292 received for the RFID/IR tag associated with the at least one medical staff (e.g., orderly 282, receptionist 284); b) RFID-based location information 294 received for the RFID/IR tag associated with the at least one medical staff (e.g., orderly 282, receptionist 284); and c) time stamp information 298 associated with IR-based location information 292 and RFID-based location information 294 received for the RFID/IR tag associated with the at least one medical staff (e.g., orderly 282, receptionist 284).

The time/proximity based level of performance (e.g., performance information 302) may concern one or more of: the quantity of time that it takes the at least one medical staff (e.g., orderly 282, receptionist 284) to perform one or more required tasks (e.g., deliver food, mop a hallway, distribute laundered clothes, collect dirty clothes); the performance level at which the at least one medical staff (e.g., orderly 282, receptionist 284) performs the one or more required tasks (e.g., deliver food, mop a hallway, distribute laundered clothes, collect dirty clothes); the performance level at which the at least one medical staff (e.g., orderly 282, receptionist 284) adheres to a schedule (e.g., when performing the above-described tasks); the overall utilization efficiency of the at least one medical staff (e.g., orderly 282, receptionist 284); the quantity of time that the at least one medical staff (e.g., orderly 282, receptionist 284) is over-scheduled (e.g., scheduled to do too much work); and the quantity of time that the at least one medical staff (e.g., orderly 282, receptionist 284) is under-scheduled (e.g., scheduled to do too little work); the quantity of time that the at least one medical staff (e.g., orderly 282, receptionist 284) interacts with the medical professional (e.g., doctor 278, nurse 280); the quantity of time that the at least one medical staff (e.g., orderly 282, receptionist 284) interacts with the medical patient (e.g., patient 286, 288); and the quantity of time that the at least one medical staff (e.g., orderly 282, receptionist 284) interacts with the medical device (e.g., ultrasound machine 290).

### Efficiency Analysis:

Tracking & analysis process 10 (in combination with computing device 14) may be configured to generate 432 efficiency information 306 concerning at least one of the plurality of wireless tags (e.g., the RFID/IR tags attached to doctor 278, nurse 280, orderly 282, receptionist 284, patient 286, patient 288, and ultrasound machine 290) based, at least in part, upon the position information (e.g., IR-based location information 292 and/or RFID-based location information 294) associated with the at least one wireless tag, and the time-based movement information (e.g., time-based movement information 300) associated with the at least one wireless tag.

Efficiency information 306 may be based upon various criteria, examples of which may include one or more of the metrics discussed above, namely: the quantity of time that the medical device is utilized for the medical patient; the quantity of time that the medical device is utilized by the medical professional; the overall utilization efficiency of the medical device; the quantity of time that the medical device is over-utilized; the quantity of time that the medical device is under-utilized; the quantity of time that the medical patient interacts with the medical professional; the quantity of time that the medical patient utilizes the medical device; the anticipated satisfaction level of the medical patient; the quantity of time that the medical patient is over-scheduled; the quantity of time that the medical patient is under-scheduled; the quantity of time that the medical professional interacts with the medical patient; the quantity of time that the medical professional utilizes the medical device; the overall utilization efficiency of the medical professional; the quantity of time that the medical professional is over-scheduled; the quantity of time that the medical professional is under-scheduled; the quantity of time that it takes the at least one medical staff to perform one or more required tasks; the performance level at which the at least one medical staff performs the one or more required tasks; the performance level at which the at least one medical staff adheres to a schedule; the overall utilization efficiency of the at least one medical staff; the quantity of time that the at least one medical staff is over-scheduled; and the quantity of time that the at least one medical staff is under-scheduled; the quantity of time that the at least one medical staff interacts with the medical professional; the quantity of time that the at least one medical staff interacts with the medical patient; the quantity of time that the at least one medical staff interacts with the medical device; the overall utilization efficiency of the medical facility; the quantity of time that the at least one medical facility is over-scheduled; the quantity of time that the at least one medical facility is under-scheduled; the overall utilization efficiency of an examination/procedure room; the quantity of time that the at least one examination/procedure room is over-scheduled; and the quantity of time that the at least one examination/procedure room is under-scheduled.

While the list of metrics that may be used when generating 432 efficiency information 306 is meant to be illustrative, it is not meant to be all inclusive. Accordingly, additional metrics may be utilized when generating 432 efficiency information 306 and are considered to be within the scope of this invention.

Once generated 432, tracking & analysis process 10 (in combination with computing device 14) may be configured to compare 434 efficiency information 306 to one or more predefined quality metrics (e.g., not shown) to determine a level of adherence. For example, if a healthcare plan requires a patient to be seen by a doctor within 15 minutes of their appointment time, by monitoring the location of the doctor and the location of the patient to determine when they are in an examination/procedure room together, adherence may be confirmed (or denied).

For example and with the implementation of the Affordable Care Act, it is foreseeable that various efficiency metrics may be defined and implemented for gauging the efficiency of various medical professionals (e.g., doctor 278, nurse 280) and medical facilities. For example, time frames may be established that define e.g., the minimum amount of time that a patient should interact with a medical professional; the maximum quantity of time that a patient should wait in a waiting room before being placed into an examination/procedure room; the maximum quantity of time that a patient should wait in an examination/procedure room before seeing a doctor; the maximum amount of time between when a patient checks into a medical facility and sees a nurse; the frequency at which a nurse checks on a patient that is admitted to a hospital; and the frequency at which a doctor meets with a patient that is admitted to a hospital.

Since tracking & analysis process 10 (in combination with computing device 14) may monitor the location of medical professionals, medical staff, medical patients, and medical devices as they move within a medical facility, the above-described interactions may be monitored. Accordingly, tracking & analysis process 10 (in combination with computing device 14) may generate 432 efficiency information 306, which may be compared 434 to any of the above-described defined metrics to determine a level of compliance with e.g., the Affordable Care Act.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data management processing apparatus, such that the instructions, which execute via the processor of the computer or other programmable data management processing apparatus, create means for implementing the functions/acts specified in the flowchart and/or block diagram block or blocks.

These computer program instructions may also be stored in a computer-readable memory that may direct a computer or other programmable data management processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data management processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method comprising:
receiving IR-based location information and RFID-based location information for each of a plurality of RFID/IR tags that are associated with and configured to be attached to a plurality of medical device within a medical facility; and
generating position information concerning each of the RFID/IR tags within the medical facility.

2. The computer-implemented method of claim 1 further comprising:
associating time stamp information with the IR-based location information and the RFID-based location information received for each of the plurality of RFID/IR tags; and
generating time-based movement information concerning each of the RFID/IR tags within the medical facility.

3. The computer-implemented method of claim 2 wherein:
at least one of the plurality of RFID/IR tags is associated with and configured to be releasably attached to at least one medical patient; and
at least one of the plurality of RFID/IR tags is associated with and configured to be releasably attached to at least one medical professional.

4. The computer-implemented method of claim 3 further comprising:
determining a time/proximity based level of performance between at least one medical device, chosen from the plurality of medical devices, and the at least one medical patient or the at least one medical professional.

5. The computer-implemented method of claim 4 wherein the time/proximity based level of performance between the at least one medical device and the at least one medical patient or the at least one medical professional is based, at least in part, upon:
the IR-based location information received for the RFID/IR tag associated with the at least one medical device and the RFID/IR tag associated with the at least one medical patient or the at least one medical professional;
the RFID-based location information received for the RFID/IR tag associated with the at least one medical device and the RFID/IR tag associated with the at least one medical patient or the at least one medical professional; and
the time stamp information associated with the IR-based location information and the RFID-based location information received for the RFID/IR tag associated with the at least one medical device and the RFID/IR tag associated with the at least one medical patient or the at least one medical professional.

6. The computer-implemented method of claim 4 wherein the time/proximity based level of performance concerns one or more of:
the quantity of time that the at least one medical device is utilized for the at least one medical patient;
the quantity of time that the at least one medical device is utilized by the at least one medical professional;
the overall utilization efficiency of the medical device;
the quantity of time that the at least one medical device is over-utilized; and
the quantity of time that the at least one medical device is under-utilized.

7. The computer-implemented method of claim 1 wherein receiving IR-based location information and RFID-based location information for each of a plurality of RFID/IR tags includes:
receiving IR-based location information from a plurality of IR-based sensors positioned within the medical facility; and
receiving RFID-based location information from a plurality of RFID-based sensors positioned within the medical facility.

8. The computer-implemented method of claim 7 wherein each of the plurality of IR-based sensors and the plurality of RFID-based sensors has a known location within the medical facility.

9. A computer program product residing on a computer readable medium having a plurality of instructions stored thereon which, when executed by a processor, cause the processor to perform operations comprising:
receiving IR-based location information and RFID-based location information for each of a plurality of RFID/IR tags that are associated with and configured to be attached to a plurality of medical devices within a medical facility; and
generating position information concerning each of the RFID/IR tags within the medical facility.

10. The computer program product of claim 9 further comprising instructions for:
associating time stamp information with the IR-based location information and the RFID-based location information received for each of the plurality of RFID/IR tags; and
generating time-based movement information concerning each of the RFID/IR tags within the medical facility.

11. The computer program product of claim 10 wherein:
at least one of the plurality of RFID/IR tags is associated with and configured to be releasably attached to at least one medical patient; and
at least one of the plurality of RFID/IR tags is associated with and configured to be releasably attached to at least one medical professional.

12. The computer program product of claim 11 further comprising instructions for:
determining a time/proximity based level of performance between at least one medical device, chosen from the plurality of medical devices, and the at least one medical patient or the at least one medical professional.

13. The computer program product of claim 12 wherein the time/proximity based level of performance between the at least one medical device and the at least one medical patient or the at least one medical professional is based, at least in part, upon:
the IR-based location information received for the RFID/IR tag associated with the at least one medical device and the RFID/IR tag associated with the at least one medical patient or the at least one medical professional;
the RFID-based location information received for the RFID/IR tag associated with the at least one medical device and the RFID/IR tag associated with the at least one medical patient or the at least one medical professional; and
the time stamp information associated with the IR-based location information and the RFID-based location information received for the RFID/IR tag associated with the at least one medical device and the RFID/IR tag associated with the at least one medical patient or the at least one medical professional.

14. The computer program product of claim 12 wherein the time/proximity based level of performance concerns one or more of:
the quantity of time that the at least one medical device is utilized for the at least one medical patient;
the quantity of time that the at least one medical device is utilized by the at least one medical professional;
the overall utilization efficiency of the medical device;
the quantity of time that the at least one medical device is over-utilized; and
the quantity of time that the at least one medical device is under-utilized.

15. The computer program product of claim 9 wherein the instructions for receiving IR-based location information and RFID-based location information for each of a plurality of RFID/IR tags include instructions for:
receiving IR-based location information from a plurality of IR-based sensors positioned within the medical facility; and
receiving RFID-based location information from a plurality of RFID-based sensors positioned within the medical facility.

16. The computer program product of claim 15 wherein each of the plurality of IR-based sensors and the plurality of RFID-based sensors has a known location within the medical facility.

17. A computing system including a processor and memory configured to perform operations comprising:
receiving IR-based location information and RFID-based location information for each of a plurality of RFID/IR tags that are associated with and configured to be attached to a plurality of medical devices within a medical facility; and
generating position information concerning each of the RFID/IR tags within the medical facility.

18. The computing system of claim 17 further configured to perform operations comprising:
associating time stamp information with the IR-based location information and the RFID-based location information received for each of the plurality of RFID/IR tags; and
generating time-based movement information concerning each of the RFID/IR tags within the medical facility.

19. The computing system of claim 18 wherein:
at least one of the plurality of RFID/IR tags is associated with and configured to be releasably attached to at least one medical patient; and
at least one of the plurality of RFID/IR tags is associated with and configured to be releasably attached to at least one medical professional.

20. The computing system of claim 19 further configured to perform operations comprising:
determining a time/proximity based level of performance between at least one medical device, chosen from the plurality of medical devices, and the at least one medical patient or the at least one medical professional.

21. The computing system of claim 20 wherein the time/proximity based level of performance between the at least one medical device and the at least one medical patient or the at least one medical professional is based, at least in part, upon:
the IR-based location information received for the RFID/IR tag associated with the at least one medical device and the RFID/IR tag associated with the at least one medical patient or the at least one medical professional;
the RFID-based location information received for the RFID/IR tag associated with the at least one medical device and the RFID/IR tag associated with the at least one medical patient or the at least one medical professional; and
the time stamp information associated with the IR-based location information and the RFID-based location information received for the RFID/IR tag associated with the at least one medical device and the RFID/IR tag associated with the at least one medical patient or the at least one medical professional.

22. The computing system of claim 20 wherein the time/proximity based level of performance concerns one or more of:
the quantity of time that the at least one medical device is utilized for the at least one medical patient;
the quantity of time that the at least one medical device is utilized by the at least one medical professional;
the overall utilization efficiency of the medical device;
the quantity of time that the at least one medical device is over-utilized; and
the quantity of time that the at least one medical device is under-utilized.

23. The computing system of claim 17 wherein the receiving IR-based location information and RFID-based location information for each of a plurality of RFID/IR tags includes:
receiving IR-based location information from a plurality of IR-based sensors positioned within the medical facility; and
receiving RFID-based location information from a plurality of RFID-based sensors positioned within the medical facility.

24. The computing system of claim 23 wherein each of the plurality of IR-based sensors and the plurality of RFID-based sensors has a known location within the medical facility.
